(19) United States
(12) Patent Application Publication
(10) Pub. No.: US 2013/0097121 A1
(43) Pub. Date: Apr. 18, 2013

(54) SYSTEM RESTORATION APPARATUS FOR A PORTABLE TERMINAL AND METHOD THEREOF

(71) Applicant: Samsung Electronics Co., Ltd, Gyeonggi-do (KR)

(72) Inventor: Ho-Sung Jung, Suwon-si (KR)

(73) Assignee: Samsung Electronics Co., Ltd, Gyeonggi-do (KR)

(21) Appl. No.: 13/651,302

(22) Filed: Oct. 12, 2012

(30) Foreign Application Priority Data
Oct. 14, 2011 (KR) 10-2011-0105246

(51) Int. Cl. G06F 7/00; G06F 17/30

(52) U.S. Cl. 707/679; 707/E17.007

(57) ABSTRACT

A system restoration apparatus for a portable terminal for changing a system of the portable terminal and easily restoring the changed system to a state before the system is changed in an Operating System (OS) of the portable terminal and a method thereof are provided. The method includes changing a system of the portable terminal, receiving a specific command and displaying a certain information item, and restoring the changed system to a state before the system is changed when at least one of the displayed certain information items is selected.

### CROSS-REFERENCE TO RELATED APPLICATION(S) AND CLAIM OF PRIORITY

The present application is related to and claims the benefit under 35 U.S.C. §119(a) to a Korean Patent Application filed in the Korean Intellectual Property Office on Oct. 14, 2011 and assigned Serial No. 10-2011-0105246, the entire disclosure of which are hereby incorporated by reference.

### TECHNICAL FIELD

The present disclosure relates to a system restoration apparatus for a portable terminal for changing a system of the portable terminal and easily restoring the changed system to a state before the system is changed in an Operating System (OS) of the portable terminal and a method thereof.

### BACKGROUND

With the spread of a large number of smart phones, users are growing more and more interested in OSs which are programs for controlling hardware and software of the smart phones such that the users uses the smart phones. Representative OSs of the smart phones may be iOS, Android, Blackberry, Windows mobile, Symbian, Meego, Bada, etc.

However, if the user wants to change settings of a system and restore the changed system to a system setting state before the system is changed in a conventional OS, he or she must change menu items through menus again one by one. For example, when the user wants to change a background picture of the smart phone, he or she changes the background picture in the order of a main menu item, an environment setup item, a display item, a picture display item, a background item, and a background picture source selection item and change item. Accordingly, there is a problem in that the user must repeat the above-described process and must change the current background picture to the previous background picture when he or she prefers the previous background picture.

Therefore, an apparatus and method for changing settings of a system and easily restoring the changed system to a system setting state before the system is changed is needed.

### SUMMARY

To address the deficiencies of the prior art, there is provided a system restoration apparatus for a portable terminal for changing a system of the portable terminal and easily restoring the changed system to a state before the system is changed in an OS of the portable terminal and a method thereof.

Another aspect of the present disclosure is to provide a system restoration apparatus for a portable terminal for providing generality to be used in all OSs used in smart phones and a method thereof.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flowchart illustrating a process of writing an UNDO list in a system restoration method of a portable terminal according to one embodiment of the present disclosure;

FIG. 2 is a flowchart illustrating a process of restoring a changed system to a state before the system is changed in a system restoration method of a portable terminal according to one embodiment of the present disclosure;

FIGS. 3A and 3B are pictures illustrating an UNDO menu and an UNDO list in a system restoration method of a portable terminal according to one embodiment of the present disclosure; and

FIG. 4 is a block diagram illustrating a configuration of a system restoration apparatus for a portable terminal according to one embodiment of the present disclosure.

### DETAILED DESCRIPTION

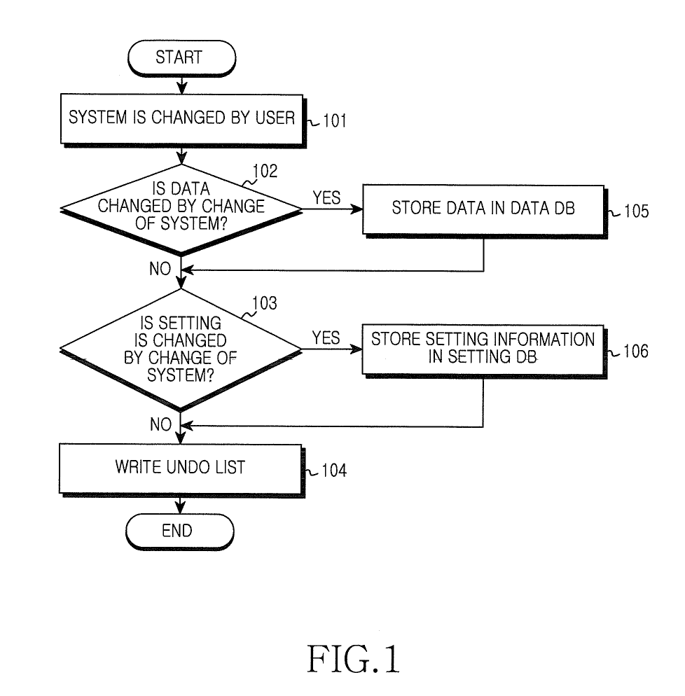

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable (or mobile) terminal or station. Exemplary embodiments of the present disclosure will be described herein below with reference to the accompanying drawings. In the following description, well-known functions or constructions are not described in detail since they would obscure subject matter of the disclosure in unnecessary detail.

FIG. 1 is a flowchart illustrating a process of writing an UNDO list in a system restoration method of a portable terminal according to one embodiment of the present disclosure.

As shown in FIG. 1, if a certain process is input from a user to change a system of the portable terminal, the system of the portable terminal is changed (step 101). Examples of the change of the system are deletion of files, installation and deletion of applications, changes of bell sounds, changes of background pictures, changes of various environment setup items, etc. For example, when the user wants to change a background picture, if a certain process is input in the order of a main menu item, an environment setup item, a display item, a picture display item, a background item, and a background picture source selection and change item, the background picture is changed to a new background picture.

The portable terminal determines whether a data is changed by the change of the system (step 102). If it is determined that the data is not changed in step 102, the portable terminal determines whether a setting is changed by the change of the system (step 103). If it is determined that the setting is not changed in step 103, the portable terminal writes an UNDO list (step 104). Information of the changed system is stored together with date and time information in the UNDO list. If the UNDO list is written, all the processes of FIG. 1 are ended.

If it is determined that the data is changed by the change of the system in step 102, a data deleted by the change of the system is stored in a data DataBase (DB) (step 105). Examples of the deletion of the data are deletion of applications, deletion of bell sounds, deletion of background pictures, etc. After the deleted data is stored in the data DB, the above-described processes of steps 103 and 104 are repeated.

Also, if it is determined that the setting is changed by the change of the system in step 103, the portable terminal stores setting information before the system is changed in a setting DB (step 106). Examples of the change of the setting are changes of bell sounds, changes of background pictures, changes of various environment setup items, etc. After the portable terminal stores the setting information before the system is changed in the setting DB, the UNDO list is written (step 104) and all the processes of FIG. 1 are ended.

The method described above in relation with FIG. 1 under of the present disclosure may be provided as one or more instructions in one or more software modules, or computer programs stored in an electronic device including a portable terminal.

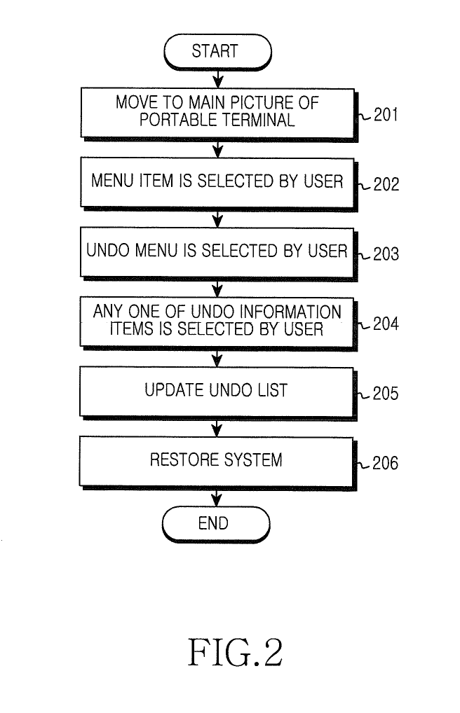

FIG. 2 is a flowchart illustrating a process of restoring a changed system to a state before the system is changed in a system restoration method of a portable terminal according to one embodiment of the present disclosure.

First of all, assuming that a user changes an old background picture to a new background picture, then decides that he or she prefers the old background picture to the new background picture while using the portable terminal, the portable terminal moves to its main picture (step 201). If the user selects a menu item on the main picture (step 202), various icons are displayed on the portable terminal. If the user inputs a specific command, a certain information item is displayed on the portable terminal. The input of the specific command may be for directly inputting a command for allowing the user to select an UNDO function in the portable terminal. Preferably, the input of the specific command is for allowing the user to select an UNDO menu among the various icons displayed on the portable terminal. If the user inputs the specific command on the portable terminal, the certain information items are displayed on the portable terminal. Herein, the certain information items may be an UNDO list. In that, an UNDO menu is selected among menus displayed on the portable terminal by the user (step 203), a previously stored UNDO list is displayed. As described above with reference to FIG. 1, information of changed information is stored together with date and time information in the UNDO list. For example, when the user changes a background picture, information of a changed system is displayed such that the user knows that the background picture was changed together with changed date and time information (e.g., 2011. 07. 18. 09:30 background picture).

If the UNDO list is displayed, an information item to restore the changed system to a state before the system is changed is selected by the user (step 204). For example, when the user wants to restore the changed background picture to the previous background picture again, he or she selects an UNDO information item displayed as “2011. 07. 18. 09:30 background picture” on the UNDO list. If any one of the UNDO information items is selected by the user, the portable terminal uses a data DB and a setting DB. For example, when an old background picture is changed to a new background picture at 09:30 on 2011. 07. 18, the old background picture is stored in the setting DB. If the above-described item on the UNDO list is selected by the user, the portable terminal may read information of the old background picture easily and quickly using the old background picture stored in the setting DB.

If any one of the UNDO information items is selected by the user, the selected UNDO item is updated (step 205). For example, if an information item of “2011. 07. 18. 09:30 background picture” is selected by the user, the above-described item is deleted. After the UNDO information item is updated, restoration of the system of the portable terminal is completed (step 206). In that, in one method, when the user wants to change a background picture, he or she must input a certain process in the order of a main menu item, an environment setup item, a display item, a picture display item, a background picture item, and a background source selection and change item. However, the prevent disclosure permits immediately restoration of a system of the portable terminal using the setting database. If the system is restored, all the processes for restoration of the system are ended.

When the user wants to restore a deleted application again, the portable terminal uses the data DB and the setting DB in step 204. In that, when the application is deleted, the deleted application is stored in the data DB and a position where the application is stored when the application is deleted is stored in the setting DB. Accordingly, in order to restore the deleted application, the portable terminal read data information of the application from the data DB, reads position information of the application when the application is deleted from the setting DB, and may easily restore its own system.

The method described above in relation with FIG. 2 under of the present disclosure may be provided as one or more instructions in one or more software modules, or computer programs stored in an electronic device including a portable terminal.

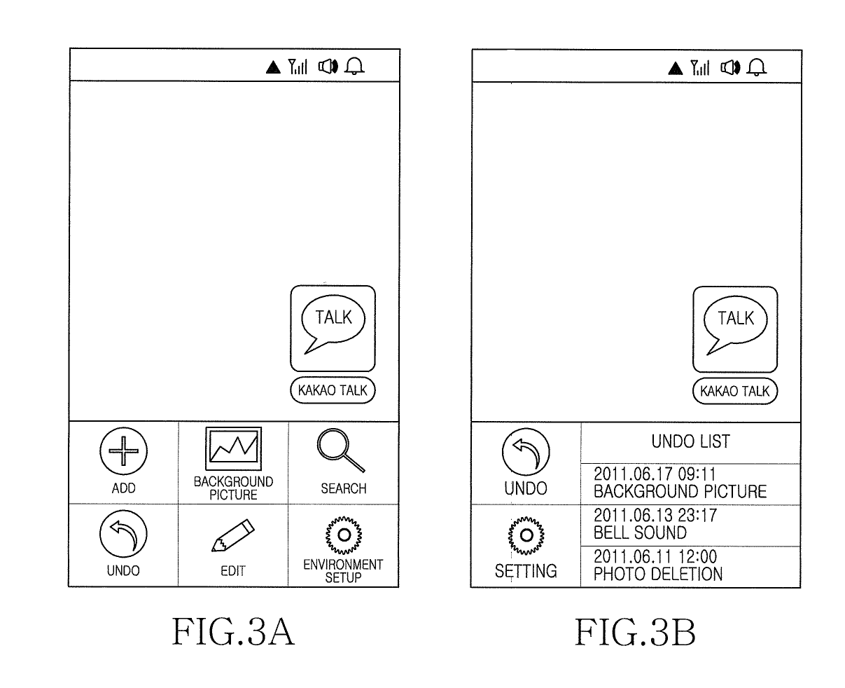

FIGS. 3A and 3B are pictures illustrating an UNDO menu and an UNDO list in a system restoration method of a portable terminal according to one embodiment of the present disclosure.

FIG. 3A is a picture illustrating an UNDO menu in a system restoration method of a portable terminal according to one embodiment of the present disclosure.

As shown in FIG. 3A, when a user changes a system of a portable terminal and wants to restore the changed system to a state before the system is changed again, the portable terminal moves to its main picture. If the user selects a menu item, as shown in FIG. 3(a), several icons are displayed.

FIG. 3(b) is a picture illustrating an UNDO list in a system restoration method of a portable terminal according to one embodiment of the present disclosure.

As shown in FIG. 3(b), if an UNDO icon is selected among displayed icons by the user, an UNDO list is displayed. For example, an UNDO information item displayed for the first time on the UNDO list is an information item of “2011. 06. 17. 09:11 background picture”. The UNDO information item indicates that a background picture displayed on a current main picture was changed at 9:11 a.m. on 17 Jun. 2011. As described in detail above with reference to FIG. 2, if the user selects an UNDO information item of “2011. 06. 17. 09:11 background picture” when he or she wants to change a new background picture to an old background picture, the new background picture is restored to the old background picture.

An UNDO information item displayed for the second time on the UNDO list of FIG. 3B is an information item of “2011. 06. 13. 23:17 bell sound”. The UNDO information item indicates that a currently set bell sound was changed at 11:17 p.m. on 13 Jun. 2011. As described above, if the user selects the UNDO information item of “2011. 06. 13. 23:17 bell sound” on the UNDO list when he or she wants to change a current bell sound to an old bell sound again, the current bell sound is immediately restored to the old bell sound.

An UNDO information item displayed for the third time on the UNDO list of FIG. 3B is an information item of “2011. 06. 11. 12:00 photo deletion”. The UNDO information item indicates that a specific photo was deleted at 12 p.m. on 11 Jun. 2011. If the user selects the UNDO information item of “2011. 06. 11. 12:00 photo deletion” when he or she wants to restore a deleted photo again, the deleted photo is immediately restored.

The user selects a setting menu which is positioned under an UNDO menu of FIG. 3B and may determine the number of UNDO information items on the UNDO list or a size of a DB. In one embodiment shown in FIG. 3B, 3 UNDO information items are displayed. However, the user selects the setting menu and may determine the number of UNDO information items. As described in detail above with reference to FIG. 1, the user may determine a size of a data DB or a setting DB. For example, if the user randomly sets a size of a DB, a data of a predetermined size or more may not be stored in the data DB or the setting DB.

The subject matter of the present disclosure may be implemented in an electronic device including a portable terminal such as, for example, a smart phone and a mobile telecommunication terminal. Hereunder, a portable terminal is used as an example for the electronic device.

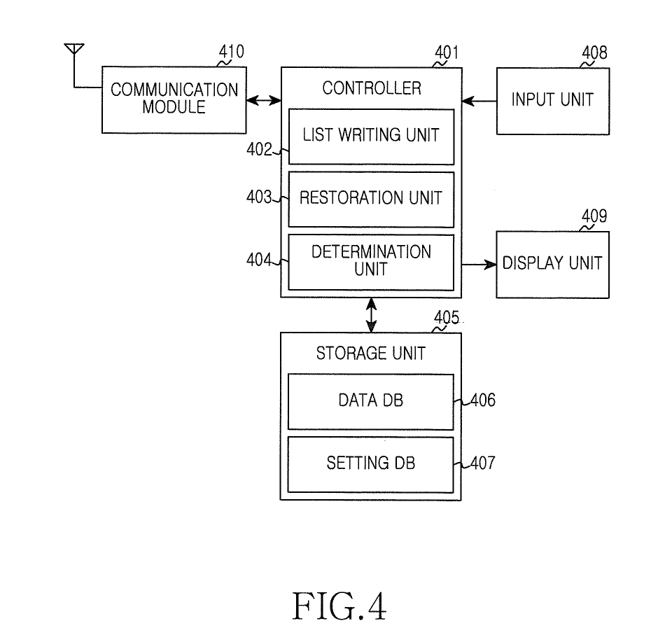

FIG. 4 is a block diagram illustrating a configuration of a system restoration apparatus for a portable terminal according to one embodiment of the present disclosure.

As shown in FIG. 4, the portable terminal using an OS according to one embodiment of the present disclosure may include a controller 401, a list writing unit 402, a restoration unit 403, a determination unit 404, a storage unit 405, a data DB 406, a setting DB 407, an input unit 408, a display unit 409, and a communication module 410.

The controller 401 controls an overall operation of the portable terminal. In one embodiment of the present disclosure, the controller 401 may include the list writing unit 402, the restoration unit 403, and the determination unit 404.

The list writing unit 402, included in the controller 401, writes an UNDO list. For example, the list writing unit 402 changes a system of the portable terminal, writes an UNDO list to which the change of the system is reflected, and updates a certain information item.

The restoration unit 403, included in the controller 401, restores the changed system to a state before the system is changed. For example, when a user selects at least one of displayed certain information items, the restoration unit 403 restores the changed system to the state before the system is changed. The restoration unit 403 receives a deleted data and setting information from the data DB 406 which stores the deleted data and the setting DB 407 which stores the setting information before the system is changed, and restores the changed system to the state before the system is changed.

The determination unit 404 is included in the controller 401. The determination unit 404 determines whether a data is changed by the change of the system and determines whether a setting is changed by the change of the system. Also, the determination unit 404 sets storage capacity of the data DB 406 which stores the deleted data and the setting DB 407 which stores the setting information before the system is changed, and sets the number of the displayed certain information items.

The storage unit 405 stores programs and data for controlling an operation of the portable terminal. The storage unit 405 according to one embodiment of the present disclosure may include the data DB 406 and the setting DB 407.

The data DB 406 is included in the storage unit 405. If it is determined that the data is changed, the data DB 406 stores a data deleted by the change of the system.

The setting DB 407 is included in the storage unit 405. If it is determined that the setting is changed by the change of the system, the setting DB 407 stores setting information before the system is changed.

The input unit 408 provides an input data generated by selection of the user to the controller 401. For example, the input unit 408 receives an UNDO command and receives any one of the UNDO information items.

The display unit 409 displays state information, a menu picture, and story information of the portable terminal according to control of the controller 401. For example, the display unit 409 displays the UNDO list.

A touch sensitive display, called as a touch screen, may be used as the display unit 409. In this situation, a touch input may be performed via the touch sensitive display.

The communication module 410 processes signals transmitted and received through an antenna to perform voice and data communication.

The controller 401 may perform an overall operation of the portable terminal. The present disclosure separately includes the controller 401, the storage unit 405, the input unit 408, the display unit 409, and the communication module 410 to separately express respective functions thereof. Accordingly, when the portable terminal is actually implemented as a product, it may be configured such that all functions of the portable terminal may be processed in the controller 401. Or, the portable terminal may be configured such that only some functions may be processed in the controller 401.

Embodiments of the subject matter of the present disclosure according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present disclosure.

Such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A system restoration method of a portable terminal, the system restoration method comprising:
changing a system of the portable terminal;
receiving a specific command and displaying a certain information item; and
restoring the changed system to a state before the system is changed when at least one of the displayed certain information items is selected.

2. The system restoration method of claim 1, wherein the change of the system includes at least one of deletion of files, installation and deletion of applications, changes of bell sounds, changes of background pictures, and changes of environment setup items.

3. The system restoration method of claim 1, further comprising writing an UNDO list to which the change of the system is reflected.

4. The system restoration method of claim 3, wherein the writing of the UNDO list comprises storing information of the changed system together with changed date and time information.

5. The system restoration method of claim 1, wherein the certain information item is a list information item including information of the changed system and changed date and time information.

6. The system restoration method of claim 1, further comprising:
determining whether a data is changed by the change of the system; and
storing a data deleted by the change of the system in a data DB when it is determined that the data is changed.

7. The system restoration method of claim 1, further comprising:
determining whether a setting is changed by the change of the system; and
storing setting information before the system is changed in a setting DB when it is determined that the setting is changed.

8. The system restoration method of claim 1, wherein the restoration of the changed system to the state before the system is changed comprises receiving a deleted data and setting information from a data DB which stores the deleted data and a setting DB which stores the setting information before the system is changed and restoring the system to the state before the system is changed.

9. The system restoration method of claim 1, further comprising updating the certain information item.

10. The system restoration method of claim 1, further comprising:
setting storage capacity of a data DB which stores a deleted data and a setting DB which stores setting information before the system is changed; and
setting the number of the displayed certain information items.

11. A system restoration apparatus for a portable terminal, the system restoration apparatus comprising:
a list writing unit configured to change a system of the portable terminal;
a display unit configured to receive a specific command and displaying a certain information item; and
a restoration unit configured to restore the changed system to a state before the system is changed when at least one of the displayed certain information items is selected.

12. The system restoration apparatus of claim 11, wherein the change of the system includes at least one of deletion of files, installation and deletion of applications, changes of bell sounds, changes of background pictures, and changes of environment setup items.

13. The system restoration apparatus of claim 11, wherein the list writing unit is configured to write an UNDO list to which the change of the system is reflected.

14. The system restoration apparatus of claim 13, wherein the list writing unit is configured to store information of the changed system together with changed date and time information.

15. The system restoration apparatus of claim 11, wherein the certain information item is a list information item including information of the changed system and changed date and time information.

16. The system restoration apparatus of claim 11, further comprising:
a determination unit configured to determine whether a data is changed by the change of the system; and
a data DB storing a data deleted by the change of the system when it is determined that the data is changed.

17. The system restoration apparatus of claim 11, further comprising:
a determination unit configured to determine whether a setting is changed by the change of the system; and
a setting DB storing setting information before the system is changed when it is determined that the setting is changed.

18. The system restoration apparatus of claim 11, wherein the restoration unit receives a deleted data and setting information from a data DB which stores the deleted data and a setting DB which stores the setting information before the system is changed and restores the system to the state existing before the system was changed.

19. The system restoration apparatus of claim 11, wherein the list writing unit is configured to update the certain information item.

20. The system restoration apparatus of claim 11, further comprising:
a determination unit configured to set storage capacity of a data DB which stores a deleted data and a setting DB which stores setting information before the system is changed and setting the number of the displayed certain information items.
